(19) United States
(12) Patent Application Publication
(10) Pub. No.: US 2025/0159763 A1
(43) Pub. Date: May 15, 2025

(54) HEATING DEVICE FOR CLOTHES CARE MACHINE

(71) Applicant: Jin Doo KIM, Yongin-si (KR)

(72) Inventor: Jin Doo KIM, Yongin-si (KR)

(21) Appl. No.: 18/838,526

(22) PCT Filed: Jan. 18, 2023
(86) PCT No.: PCT/KR2023/000861

§ 371 Date: Aug. 14, 2024

(30) Foreign Application Priority Data
Feb. 15, 2022 (KR) 10-2022-0019732
Feb. 22, 2022 (KR) 10-2022-0022801
Feb. 28, 2022 (KR) 10-2022-0025966
Feb. 28, 2022 (KR) 10-2022-0025967
Apr. 12, 2022 (KR) 10-2022-0045187

(51) Int. Cl. H05B 3/22; D06F 39/04; D06F 39/08; D06F 103/18

(52) U.S. Cl. CPC H05B 3/22; D06F 39/04; D06F 39/087; D06F 2103/18

(57) ABSTRACT

A heating device for a clothes care machine, the heating device comprising: a heater plate which is a plate having a predetermined thickness and has a heating surface formed on the outer surface thereof; a heating electrode layer which provides an electrode pad at one side thereof and is formed on the inner surface of the opposite surface to the heating surface of the heater plate; a lead electrode having one end connected to the electrode pad to supply power to the heating electrode layer; a housing accommodating and protecting a portion of each of the heater plate and the lead electrode such that the heating surface is exposed; a bracket coupled to a side portion of the housing and fixing the other end of the lead electrode while exposing the other end of the lead electrode to the outside.

### TECHNICAL FIELD

The present invention relates to a heating device, and more specifically, to a heating device that is applied to a clothes care machine such as a washing machine or a refresher and is used to instantaneously heat water.

### BACKGROUND ART

In general, a clothes care machine includes a washing machine, a dryer, a refresher, and the like, in which the washing machine is largely divided into a pulsator-type washing machine in which washing is performed by a water stream generated by rotating a plate-shaped pulsator, and a drum washing machine in which washing is performed by rotating a laid drum and using washing water supplied to the inside of the drum, drop of laundry, and a frictional force.

Among them, the drum washing machine is less tangled than the pulsator-type washing machine and an amount of washing water and detergent required during a washing cycle is small, so that a demand of users is increasing rapidly. The drum washing machine has a water storage tub installed in an inner space of a cabinet forming an outer shape thereof, and a washing tub rotatably installed in the water storage tub.

Meanwhile, a drum washing machine, in which a heater (heating device) is installed on a bottom surface of a water storage tub to heat washing water and make the washing water hot, and generates hot water by itself inside the washing machine, is also being released. Accordingly, even when cold water is introduced into the water storage tub in winter, the heater is heated to a temperature appropriate for washing while being operated, so that it is not necessary to separately connect to a faucet through which hot water is discharged.

FIG. 1 is a sectional view showing a general configuration of a drum washing machine, and FIG. 2 is a perspective view showing a heating device for a drum washing machine according to the related art.

Referring to FIG. 1, the drum washing machine generally includes a cabinet 1 having an accommodation space therein, a water storage tub 2 installed in the cabinet 1, a washing tub 3 rotatably disposed in the water storage tub 2, a heating device 4, that is, a heater installed between the water storage tub 2 and the washing tub 3, and a driving motor 5 for rotating the washing tub 3. In addition, the drum washing machine has a water supply port and a detergent supply port each of which is provided at an upper portion of the cabinet 1, and a drain port provided at a lower portion of the cabinet 1.

The heating device 4 is configured as a sheath heater to boil water or generate steam for boiling washing, steam washing, or sterilization. Referring to FIG. 2, the heating device 4 includes a heating pipe 11 for generating heat, a bracket 12 for fixing one end of the heating pipe 11 and mounting the heating device on the water storage tub 2 of the drum washing machine, and an electrode terminal 13 connected to an end of the heating pipe 11 while passing through the bracket 12 to supply electricity. A heating wire (not shown) having a coil shape is provided inside the heating pipe 11, and the heating wire is connected to the terminal 13 through a temperature fuse (not shown) for preventing overheating.

In the washing machine having the above-described configuration, the water storage tub 2 is filled with the cold water while being filled with the cold water, and the heating device 4 is driven to heat the cold water after the cold water is filled in such a degree that the heating device 4 is sufficiently submerged therein. After the cold water is heated to a predetermined temperature, the washing machine is driven to perform washing.

Meanwhile, water supplied to the water storage tub includes a limestone component, and the limestone component included in the water is attached to a surface of the high-temperature heating pipe by heat generated when the heating device boils water, thereby forming a limestone layer. The limestone layer blocks a contact between the temperature fuse and water, so that heat of the heating wire is transferred to the temperature fuse as it is, thereby causing a problem in that the temperature fuse does not operate accurately or a lifespan of the heating device is shortened.

In addition, a conventional heating device applied to the drum washing machine is driven after the water storage tub is completely filled with water, that is, after the supply of the washing water is completed. Therefore, there is a disadvantage in that it takes a lot of time until a washing cycle starts after the water is heated since the washing water starts to be supplied.

In addition, a conventional heater has a disadvantage in that defective parts generated during manufacture of a product are not recycled and are discarded as waste materials, thereby causing waste of resources and environmental pollution.

### DISCLOSURE

### Technical Problem

The present invention has been proposed to solve the above problems, and an object of the present invention is to provide a heating device for a clothes care machine capable of solving problems of malfunction and lifespan shortening due to a limestone layer.

Another object of the present invention is to provide a heating device for a clothes care machine capable of preventing malfunction due to non-contact by improving a contact ratio of an electrode terminal.

Another object of the present invention is to provide a heating device for a clothes care machine capable of shortening a time until a washing cycle starts since washing water starts to be supplied.

Another object of the present invention is to provide a heating device for a clothes care machine capable of employing a heating device mounted on a conventional clothes care machine through replacement of the same while improving heating efficiency.

Another object of the present invention is to provide a heating device for a clothes care machine, which minimizes waste of resources by recycling defective parts even if the defective parts are generated during manufacture.

### Technical Solution

To solve the above problems, According to the present embodiment, a heating device for a clothes care machine, which is mounted in a water storage space inside the clothes care machine to heat water, includes: a heating plate which is a plate having a predetermined thickness and formed on an outer surface thereof with a heating surface; a heating electrode layer which provides an electrode pad at one side thereof and is formed on an inner surface of a side of the heating plate, which is opposite to the heating surface; a lead electrode which has one end connected to the electrode pad to supply power to the heating electrode layer; a housing which accommodates and protects the heating plate and a portion of the lead electrode such that the heating surface is exposed; and a bracket which is coupled to a side of the housing to fix the other end of the lead electrode while exposing the other end of the lead electrode to an outside, wherein the housing is mounted in the clothes care machine such that the housing is located in the water storage space to heat the water while being submerged in the water filled in the water storage space.

In addition, the heating surface may be bent such that a central region of the heating plate is concave inwardly.

In addition, the heating surface may be configured as a slope structure having a concavely bent region with a variable depth.

In addition, the heating plate may be formed with a reinforcement flange that is formed by bending an edge of the heating plate.

In addition, the heating device may further include a resistance electrode layer which is formed on a surface of the heating plate within the heating electrode layer to measure a resistance according to a temperature of the heating plate.

In addition, the heating electrode layer and the resistance electrode layer may be formed by printing a heating paste on a surface of the heating plate.

In addition, the resistance electrode layer may function as a heating electrode layer to which the power is applied so as to allow the resistance electrode layer to heat a surface of a local area of the heating plate.

In addition, an upper surface of the housing may be concavely recessed to form an avoidance groove in order to prevent a contact with a rotating body.

In addition, the heating device may further include a sealing member which is interposed between the housing and the bracket to prevent leakage of the water filled in the water storage space.

In addition, the housing may include a movement prevention unit which prevents movement of the sealing member.

In addition, the movement prevention unit may include a support part protruding along a surface of the housing, and a pressing part extending from an upper end of the support part toward the sealing member, and the pressing part may be configured to prevent the movement of the sealing member by pressing an end of the sealing member.

In addition, the heating device may further include a water level detection sensor which is mounted on the housing to detect a water level in the water storage space.

In addition, the housing may have a concave waterway along an edge of an upper surface thereof, and the water level detection sensor may be installed such that one end thereof extends to the waterway, so as to detect a level of water introduced into the waterway.

In addition, the waterway may have a blocking wall formed at an outer end thereof so that the waterway is blocked from an outer region, and may be configured to introduce the water to an inside or to discharge the water to the outside through a through-hole formed in the blocking wall.

In addition, the lead electrode may be integrally coupled to the bracket while passing through the bracket, and may include a contact terminal located inside the bracket and a lead terminal located outside the bracket, and the housing may have adhering protrusions formed on an inner surface thereof to improve a contact force by pressing the contact terminal with the electrode pad.

### Advantageous Effects

According to the present invention, a limestone layer is not formed on a surface of the heating device, thereby preventing malfunction and obtaining a long lifespan.

In addition, according to the present invention, a contact ratio of the electrode terminal is improved, thereby preventing malfunction due to non-contact.

In addition, according to the present invention, heating is performed when a certain amount of washing water is supplied, thereby shortening a time until the washing cycle starts.

In addition, the heating device according to the present invention may be compatible with a conventional heating device mounted on a clothes care machine, thereby significantly improving convenience of use.

In addition, according to the present invention, when defective parts are generated during formation of a heating electrode layer, a printed layer may be reused by washing, thereby preventing waste of resources.

### DESCRIPTION OF DRAWINGS

FIG. 1 is a view showing a general configuration of a drum washing machine.

FIG. 2 is a view showing a heating device according to the related art.

FIG. 3 is a view showing a heating device according to the present embodiment.

FIG. 4 is a view showing a bottom surface of the heating device according to the present embodiment.

FIG. 5 is a view showing an exploded structure of the heating device according to the present embodiment.

FIG. 6 is a view showing a sealing structure of the heating device according to the present embodiment.

FIG. 7 is a view showing a state in which the heating device according to the present embodiment is submerged in washing water.

FIG. 8 is a view showing an internal structure of a case of the heating device according to the present embodiment.

FIGS. 9 and 10 are views showing an assembling process of the heating device according to the present embodiment.

FIG. 11 is a flowchart showing a washing process of a washing machine according to the present embodiment.

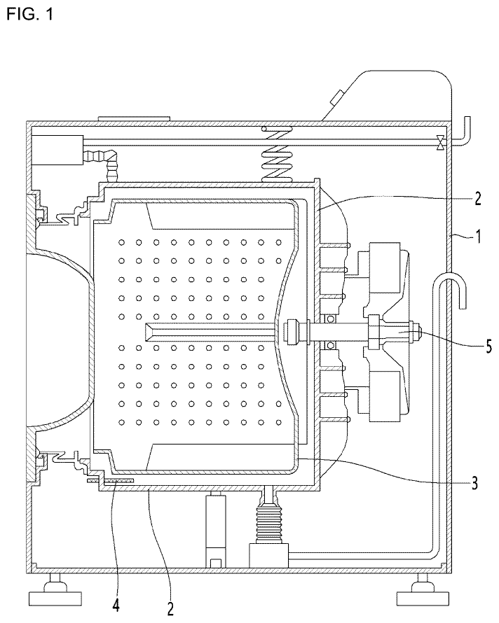

### MODE FOR INVENTION

The present invention and the technical objects achieved by the implementation of the present invention will become apparent by the preferred embodiments described below. Hereinafter the preferred embodiments of the present invention will be described in detail with reference to accompanying drawings.

It is to be understood that the differences between the present embodiments, which will be described below, are not mutually exclusive. That is, it should be understood that the specific shapes, structures, and characteristics described without departing from the technical spirit and scope of the present invention may be implemented as other embodiments in relation to one embodiment, and the position or arrangement of individual components in the disclosed embodiments may be changed, and similar reference numerals in the drawings refer to the same or similar functions over various aspects, and the lengths, areas, thicknesses, and the like may be exaggerated for convenience. In the description of the present embodiment, expressions such as “up”, “down”, “front”, “rear”, “first”, “second”, and the like indicate a relative position, direction, and order, and the technical meaning is not limited to the dictionary meaning.

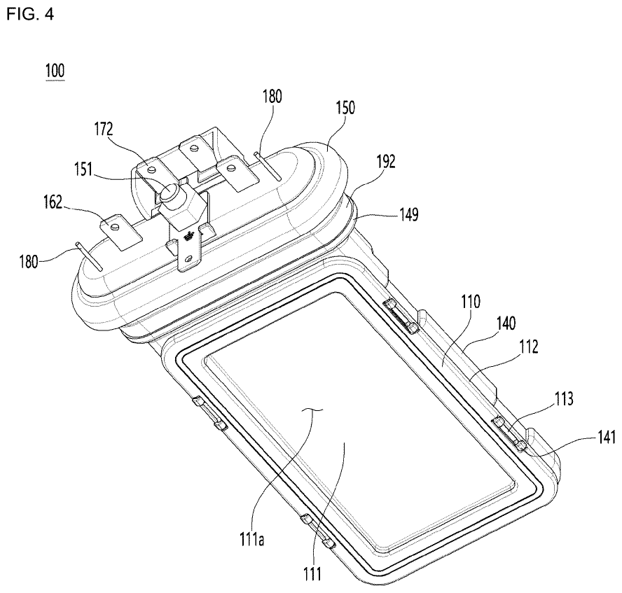

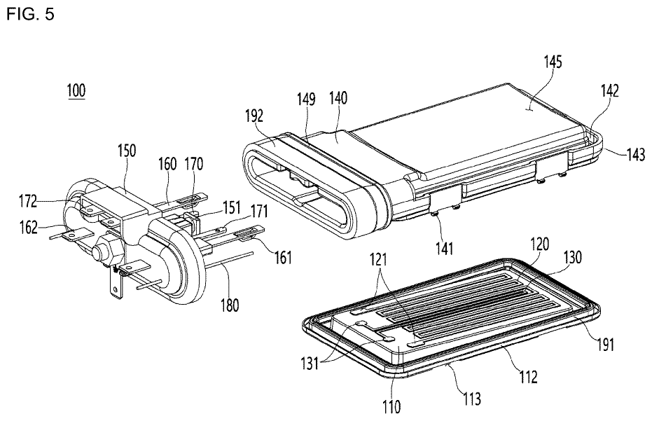

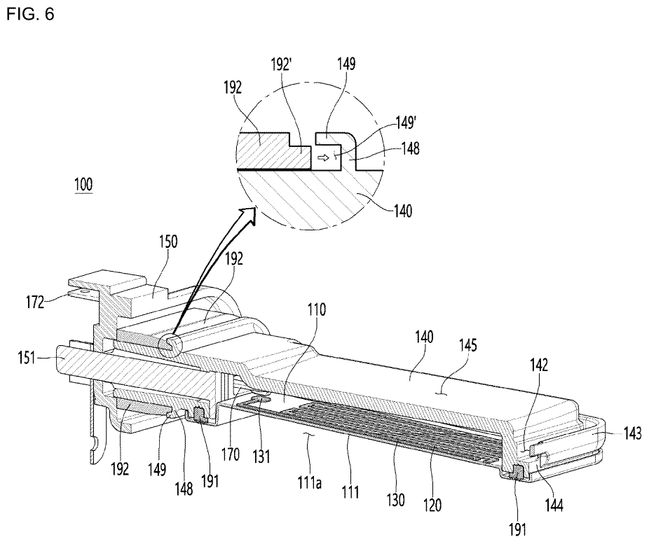

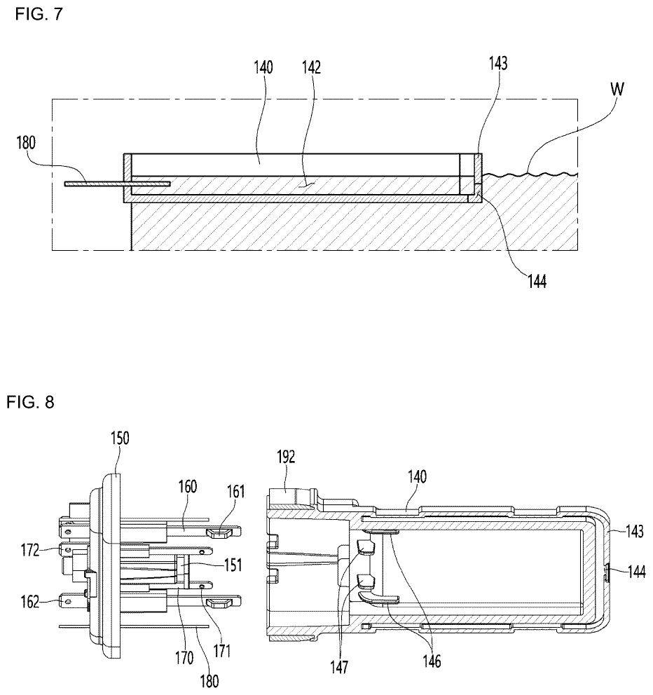

FIG. 3 is a view showing a heating device according to the present embodiment, FIG. 4 is a view showing a bottom surface of the heating device according to the present embodiment, FIG. 5 is a view showing an exploded structure of the heating device according to the present embodiment, FIG. 6 is a view showing a sealing structure of the heating device according to the present embodiment, and FIG. 7 is a view showing a state in which the heating device according to the present embodiment is submerged in washing water.

Referring to these drawings, a heating device 100 of the present embodiment includes: a heating plate 110 which generates heat; a heating electrode layer 120 which is formed on an upper surface of the heating plate; a resistance electrode layer 130 which is formed on the upper surface of the heating plate 110 in a region in which the resistance electrode layer 130 does not overlap with the heating electrode layer 120; a housing 140 which accommodates and protects the heating plate 110; a bracket 150 for mounting the heating device 100 to a water storage tub 2; a first lead electrode 160 which is coupled to the bracket to supply power to the heating electrode layer 120; a second lead electrode 170 which is coupled to the bracket 150 to supply the power to the resistance electrode layer 130; and a water level detection sensor 180 which detects a level of water filled in the water storage tub 2 of a washing machine while being coupled to the bracket 150.

The heating device 100 is a planar heating element, and when power is supplied through a pair of first lead electrodes 160, a current flows through the heating electrode layer 120 to generate high-temperature heat in the heating electrode layer 120, and the generated heat is emitted through the heating plate 110 to heat water making contact with a surface of the heating plate 110.

The heating plate 110 is formed of a material having insulation properties and excellent thermal conductivity. Further, the heating plate 110 is formed of a plate having a predetermined thickness, in which a central region thereof is bent concavely and a concave surface (lower surface) thereof forms a heating surface 111 that heats water making contact therewith. For example, the heating plate 110 is formed of a rectangular plate of a SUS material, and as shown in FIG. 4, the central region has a bending structure concavely recessed in a rectangular shape, and a concave groove formed by bending provides the heating surface 111.

When high-temperature heat is generated in the heating electrode layer 120, the heating plate 110 may have a large temperature deviation in the central region in which an electrode layer is formed and an edge region in which the electrode layer is not formed, resulting in deformation of a shape as the plate is bent or twisted due to the temperature deviation. Since thermal deformation of the heating plate 110 is significantly generated as a thickness of the material is reduced, the heating plate 110 needs to have a predetermined thickness or more in order to prevent the thermal deformation, so that a weight of the heating device is increased and manufacturing costs according to material costs are increased.

However, when the concave heating surface 111 is formed in the central region by employing bending processing as in the present embodiment, both side surfaces of the heating surface 111 functions as reinforcing ribs, so that there is an effect of preventing thermal deformation while reducing the thickness of the heating plate 110. For example, the heating plate 110 of the present embodiment may have a thickness of equal to or less than 0.6 mm, and thermal deformation does not occur even at such a reduced thickness.

In addition, in the heating plate 110 of the present embodiment, the concave heating surface 111 has a slope structure as shown in FIGS. 4 and 6. That is, a heating space 111a, which is formed at a lower portion of the heating plate 111 by the concave groove, has one side formed relatively deeper and shallower toward the other side.

The heating device 100 operates inside the washing machine while being submerged in water, and after washing is completed, contaminated washing water is discharged. In this case, since washing water does not necessarily remain on the heating surface 111 of the concave groove, the heating device 100 is mounted such that the concave heating surface 111 faces downward. Therefore, the surface (lower surface) of the heating plate 110 forms the heating surface 111 of a groove shape that is recessed upward, and the heating space 111a is formed at the lower portion of the heating plate 110. In this case, when the water storage tub 2 of the washing machine is filled with water, an air pocket may be formed in the concave heating space 111a.

When the heating surface 111 is formed horizontally parallel to a water surface, the air pocket is formed in the entire region of the heating surface 111, and even when the water storage tub 2 is filled with water, water may not make contact with the heating surface 111, so that the heating plate 110 may be damaged due to overheating. However, when the heating surface 111 has a slope structure as in the present embodiment, the air pocket may be formed only in a partial space of the uppermost end of the heating space 111a, so that a space in which the air pocket may be formed is minimized, thereby preventing overheating and damage of the heating place 110 due to the air pocket. In this case, it is preferable that a surface of a region in which electrode pads 121 and 131 are formed is inclined such that the surface is located relatively high.

In addition, the heating plate 110 of the present embodiment has an edge that is finished while being bent or curled to one side, thereby forming a reinforcement flange 112. The reinforcement flange 112 may also prevent deformation of the heating plate 110. It is preferable that the reinforcement flange 112 is formed to have a height lower than that of the heating surface 111 so as not to interfere with a process of forming the heating electrode layer 120 on the heating surface 111.

In addition, when the heating plate 110 of the present embodiment is coupled to housing 140, a fastening unit such as a screw may be used, and the heating plate 110 may be coupled to the housing 140 by self-structures of the heating plate 110 and the housing 140. To this end, the reinforcement flange 112 of the heating plate 110 may further have a plurality of fastening holes 113, the housing 140 has a plurality of fastening protrusions 141 of a hook structure, which are formed at positions corresponding to the fastening holes 113, and the heating plate 110 is coupled to the housing 140 by fastening the fastening protrusions 141 and the fastening holes 113.

The heating electrode layer 120 may be formed by printing a conductive heating paste having a predetermined resistance on the surface of the heating plate 110, and may be formed on a surface (upper surface) of a side of the heating plate 110, which is opposite to the heating surface 111, as shown in the drawings. The heating electrode layer 120 may have a strip shape with a predetermined width and length, and both ends thereof provides a pair of first electrode pads 121 making contact with the first lead electrode 160.

The resistance electrode layer 130 is formed by printing a conductive heating paste having a predetermined resistance on a region in which the heating electrode layer 120 is not formed, that is, a surface of the heating plate 110 within the heating electrode layer 120. The resistance electrode layer 130 may have a strip shape with a predetermined width and length, and both ends thereof provides a pair of second electrode pads 131 making contact with the second lead electrode 170.

The resistance electrode layer 130 may predict a temperature of heated water by measuring a resistance of the heating electrode layer 120 according to a temperature. Generally, In general, since the resistance varies depending on the temperature, the resistance of the heating electrode layer 120, which varies depending on the temperature of the heating plate 110, is measured through the resistance electrode layer 130 to control power supplied to the heating electrode layer 120 such that the heating plate 110, which heats water, is heated to a predetermined constant temperature. To this end, the resistance electrode layer 130 may be formed by printing a conductive paste having the same material as the heating electrode layer 120. The resistance electrode layer 130 is connected to an external resistance measurement module through the second lead electrode 170.

Meanwhile, the resistance electrode layer 130 may function as another heating electrode layer which heats the heating plate 110. That is, the heating device 100 may be used for the purpose of applying heat to a local area by the heating plate 110, as necessary. In this case, the resistance electrode layer 130 is formed of the conductive paste having the same material as the heating electrode layer 120 and has a relatively narrow area, the heating plate 110 may be heated in a local area by applying power to the resistance electrode layer 130. Therefore, the resistance electrode layer 130 may be selectively connected to an external resistance measurement module or power supply module through the second lead electrode 170.

As described above, even if the heating electrode layer 120 and the resistance electrode layer 130, which are formed by printing the conductive paste, have defects that occur during printing, the heating plate 110 may be reused by washing the printing layer. Therefore, waste of resources due to the defects in a manufacturing process may be minimized, and environmental pollution may be prevented.

The housing 140 allows the heating plate 110 to be coupled to an opening at a lower side thereof, and allows the bracket 150 to be coupled to an opening at a side surface thereof. In addition, the housing 140 accommodates the heating plate 110, the first lead electrode 160, and the second lead electrode 170 to insulate and protect the same from the outside, and is formed of a non-conductive material having high heat resistance. The housing 140 has a sufficient space for accommodating the heating plate 110 therein, and has a lower portion that accommodates the heating plate 110 while exposing the heating surface 111 of the heating plate 110 to the outside. In addition, the housing 140 may be formed on a side thereof with the fastening protrusion 141 such that the heating plate 110 may be coupled thereto. The plurality of coupling protrusions 141 may have a hook shape, and may be formed at positions corresponding to the fastening holes 113 of the heating plate 110.

Further, the housing 140 may form a waterway 142 having a concave groove shape along an edge of an upper surface thereof. The waterway 142 is blocked from the outside in a horizontal direction through a blocking wall 143 formed at an outer end thereof, and is connected to the outside in the horizontal direction through a through-hole 144 formed in the front of the housing 140. Therefore, in a state in which the heating device 100 is mounted on the washing machine, the waterway 142 is filled with water through the through-hole 144 when the water storage tub 2 is filled with the water, and when the water is drained after washing is finished, the water filled in the waterway 142 is drained again through the through-hole 144. The water level detection sensor 180 is located in the waterway 142 to detect a level of water filled in the water storage tub 2.

Further, an upper surface of the housing 140 may have a concavely curved shape to form an avoidance groove 145. The avoidance groove 145 is formed in a curved surface in a direction corresponding to a circumferential surface of a washing tub 3, and preferably has a curvature corresponding to the circumferential surface of the washing tub 3.

Generally, a drum washing machine is provided with a driving motor 5 having a rotation axis and formed on one side of a cabinet 1, and the washing tub 3 is horizontally disposed as one side thereof is coupled to the rotation axis. In this case, the rotation axis rotates, the washing tub 3 also rotates, and one side of the washing tub 3 rotates while being fixed by the rotation axis, but the other side (door side) slightly shakes and rotates with a trajectory that is larger than an actual radius of the washing tub 3. In addition, the heating device 100 is coupled such that a heating region overlaps the washing tub 3 and is located at a lower portion of the washing tub 3, and is coupled at a position close to the washing tub 3 as possible in order to efficiently utilize the space inside the washing machine.

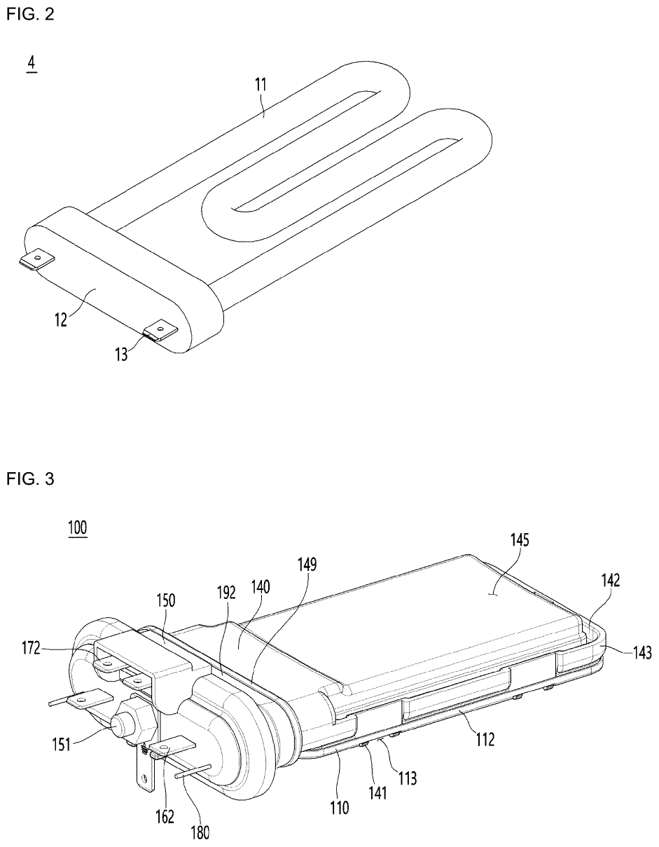

In this case, since the washing tub 3 rotates with the trajectory larger than the actual radius, there is a risk that the washing tub 3 may collide with the heating device, that is, the housing 140. Therefore, in the heating apparatus 100 of the present embodiment, the avoidance groove 145 having a concavely curved surface corresponding to the circumferential surface of the washing tub 3 may be formed in the upper surface of the housing 140, thereby preventing collision or interference between the housing 140 and the washing tub 3 when the washing machine is driven. In addition, in the heating device 100 of the present embodiment, the avoidance groove 145 is formed in the housing 140, so that the heating device (see FIG. 2) having the sheath structure may be replaced with the heating device (see FIG. 3) having the planar structure without changing the structure of the conventional washing machine, thereby enabling compatibility of the heating device.

In addition, the housing 140 includes at least a pair of first adhering protrusions (see 146 of FIG. 7) and at least a pair of second adhering protrusions (see 147 of FIG. 7) formed therein in order to make contact with the first electrode pad 121 and the second electrode pad 131, respectively, by pressing the first lead electrode 160 and the second lead electrode 170. The detailed configurations and functions of the adhering protrusions 146 and 147 will be described below.

Further, the housing 140 is coupled to the heating plate 110 through a first sealing member 191, and is coupled to the bracket 150 through a second sealing member 192.

That is, the first sealing member 191 is interposed between the heating plate 110 and the housing 140 to seal a portion between the heating plate 110 and the housing 140. The second sealing member 192 is interposed between the housing 140 and the bracket 150 to seal a portion between the housing 140 and the bracket 150. The first and second sealing members 191 and 192 may be formed of a silicon material having a high heat resistance and elasticity.

Further, the second sealing member 192 seals a portion between the housing 140 and the water storage tub 2 when the bracket 150 is coupled to the water storage tub 2, thereby providing leakage of water filled in the water storage tub 2. The second sealing member 192 has a ring shape surrounding an outer surface of the cylindrical housing 140, and is not necessarily moved or lifted from the surface of the housing 140 when being coupled to the water storage tub 2. Therefore, a movement prevention unit is formed between the housing 140 and the second sealing member 192 to prevent movement of the second sealing member 192.

Referring to FIG. 6 in detail, the housing 140 has a support part 148 protruding along a surface thereof, in which upper end of the support part 148 is formed with a pressing part 149 extending toward the second sealing member 192, and a fixing groove 149′ into which a fixing protrusion 192′ of the second sealing member 192 is fixedly inserted is formed at a lower side of the pressing part 149. In addition, the second sealing member 192 has a lower end protruding outward to form a fixing protrusion 192′ inserted into the fixing groove 149′. In this case, a thickness of the fixing protrusion 192′ is formed to be at least equal to or slightly larger than a height of the fixing groove 149′, and is fixed to the fixing groove 149′ while being inserted into the fixing groove 149′ by force fitting. The second sealing member 192 may be closely and fixedly adhered to the surface of the housing 140 by the movement prevention unit having the above-described configuration, and is prevented from being moved or lifted, thereby exhibiting excellent sealing force and a leakage preventing effect.

The bracket 150 fixes the first and second lead electrodes 120 and 130 while being coupled to the housing 140 so as to seal the side opening of the housing 140, through which the first and second lead electrodes 120 and 130 are exposed, and allows the heating device 100 to be mounted on the water storage tub 2. In addition, the bracket 150 may be provided at a central region thereof with a fastening unit 151 for fastening the bracket 150 with the housing 140.

Referring to FIG. 5, the bracket 150 constitutes a single module in which the first lead electrode 160, the second lead electrode 170, and the water level detection sensor 180 are integrally formed while fixing the same. In addition, one end of each of the first lead electrode 160, the second lead electrode 170, and the water level detection sensor 180 extends inward of the bracket 150, and the other end thereof is exposed to the outside of the bracket 150. The bracket 150 is formed of an injection-molded product of an insulating material, and the first lead electrode 160, the second lead electrode 170, and the water level detection sensor 180 are formed of a conductive metal material, and thus the bracket 150, the first lead electrode 160, the second lead electrode 170, and the water level detection sensor 180 may be integrally formed by a double injection process using the first lead electrode 160, the second lead electrode 170, and the water level detection sensor 180 serving as insert products.

The first lead electrode 160 has a configuration of supplying power to the heating electrode layer 120, and a pair of conductive metal wires may be used. One end of the first lead electrode 160 extends inside the housing 140 to form a first contact terminal 161 and make contact with the first electrode pad 121, and the other end thereof passes through the bracket 150 and is exposed to the outside so as to form a first lead terminal 162, so that the first lead electrode 160 is connected to a power supply module (not shown).

The second lead electrode 170 has a configuration of supplying power to the resistance electrode layer 130, and a pair of conductive metal wires may be used. One end of the second lead electrode 170 extends inside the housing 140 to form a second contact terminal 171 and make contact with the second electrode pad 131, and the other end thereof passes through the bracket 150 and is exposed to the outside so as to form a second lead terminal 172, so that the second lead electrode 160 is connected to a power supply module (not shown).

The water level detection sensor 180 has a configuration in which a level of water (washing water) filled in the water storage tub is detected so that the heating device may be driven. Since a case in which water is detected by the water level detection sensor 180 means a state in which the heating device 100 may be driven, that is, the water is filled up to a water level at which the heating device 100 is submerged, the heating device may be driven while the water storage tub 2 is filled with water. Therefore, since the heating device 100 is driven in advance to heat the water before the water storage tub is completely filled with an amount of water for washing, a time required for heating the water to a temperature at which washing is possible may be shortened. To this end, the water level detection sensor 180 may be configured as a pair of electrode rods having one end extending inside the waterway 142 of the housing 140 and the other end exposed to the outside of the bracket 150, and may be configured as various types of sensors without being limited thereto as long as it is a unit capable of detecting the water level.

Further, the water level detection sensor 180 is installed in the waterway 142 protected from the outside by the blocking wall 143. Generally, waves (water waves) are generated while the water storage tub 2 is filled with water, and accuracy of water level detection may be significantly reduced by the wave. Therefore, as shown in FIG. 7, when the waterway 142 is protected by the blocking wall 143, waves w are severe in the water filled outside the waterway 142, but the water introduced into the waterway 142 does not generate waves and the water level rises to a constant state, thereby improving the accuracy of water level detection.

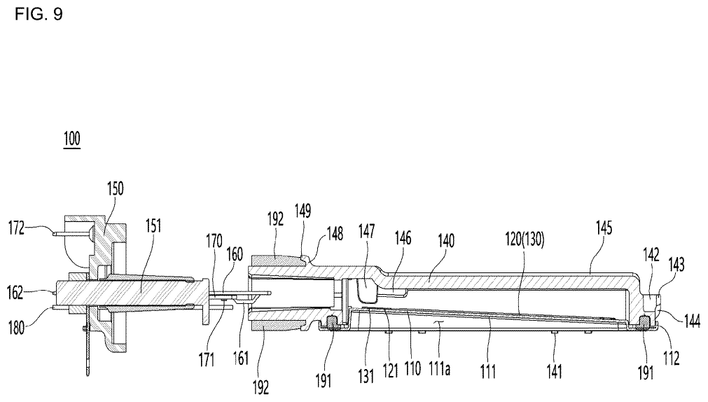

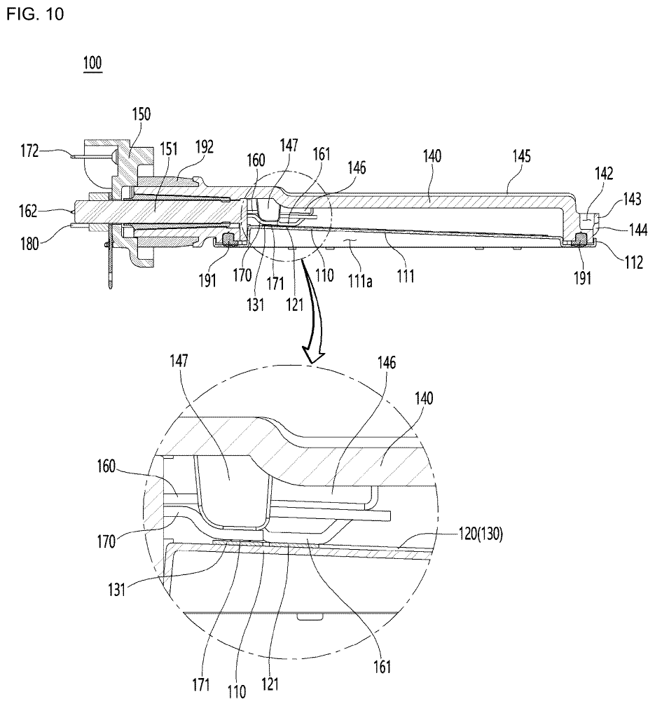

FIG. 8 is a view showing an internal structure of a case of the heating device according to the present embodiment, and FIGS. 9 and 10 are views showing an assembling process of the heating device according to the present embodiment.

Referring to FIG. 8, the housing 140 has the first adhering protrusion 146 and the second adhering protrusion 147 formed on an inner upper surface thereof. The first adhering protrusion 146 and the second adhering protrusion 147 press the first lead electrode 160 and the second lead electrode 170 to make contact with the first electrode pad 121 and the second electrode pad 131, respectively. The first adhering protrusion 146 is formed at a position corresponding to the first electrode pad 121, and the second adhering protrusion 147 is formed at a position corresponding to the second electrode pad 131. The first adhering protrusion 146 and the second adhering protrusion 147 protrude downward from the upper surface of the housing, and are formed to have a gentle slope in a direction in which the first adhering protrusion 146 and the second adhering protrusion 147 may enter so as to press the first lead electrode 160 and the second lead electrode 170.

In the heating device 110 of the present embodiment, the heating plate 110 is coupled to the lower opening of the housing 140, and the bracket 150 in which the lead electrodes 160 and 170 are integrally formed is coupled to the side opening. During the coupling of the bracket 150, the first and second lead electrodes 160 and 170 are electrically connected to the heating electrode layer 120 and the resistance electrode layer 130 while making contact with the heating electrode layer 120 and the resistance electrode layer 130, respectively.

Referring to FIGS. 9 and 10 in detail, the heating plate 110 is coupled to the housing 140 through the first sealing member 191. The heating plate 110 and the housing 140 may be coupled to each other through a structure of the fastening hole 113 and the fastening protrusion 141. In addition, the heating electrode layer 120 and the resistive electrode layer 130 having the pair of first electrode pads 121 and the pair of second electrode pads 131 are formed on the upper surface of the heating plate 110.

Further, the second sealing member 192 is coupled to an outer circumferential surface of the housing 140 to which the bracket 150 is coupled in advance.

In addition, the bracket 150, to which the first lead electrode 160, the second lead electrode 170, and the water level detection sensor 180 are coupled, is coupled to the side of the housing 140. In this case, the first contact terminal 161 of the first lead electrode 160 and the second contact terminal 171 of the second lead electrode 170 are close to the first electrode pad 121 and the second electrode pad 131 while being inserted into the housing 140.

Subsequently, when the bracket 150 is completely coupled to the housing 140, as shown in FIG. 10, the first contact point terminal 161 of the first lead electrode 160 and the second contact point terminal 171 of the second lead electrode 170 are pushed by the first adhering protrusion 146 and the second adhering protrusion 147, respectively, to make contact with the first electrode pad 121 and the second electrode pad 131.

Since the electrode pads 121 and 131 are formed on a reverse slope of the heating plate 110 as in the present embodiment, even though the contact terminals 161 and 171 are located at the electrode pads 121 and 131, the contact terminals 161 and 171 may be spaced apart from the electrode pads 121 and 131 in a vertical direction. Due to the structure of the heating plate 110, it is difficult for the contact terminals 161 and 171 to make contact with the electrode pads 121 and 131. Therefore, as in the present embodiment, the adhering protrusions 146 and 147 push the contact terminals 161 and 171 by pressing the same downward, so that the contact terminals 161 and 171 may make contact with the electrode pads 121 and 131, respectively, and the lead electrodes 160 and 170 and the electrode layers 120 and 130 may be stably and electrically connected simultaneously with the coupling of the bracket 150.

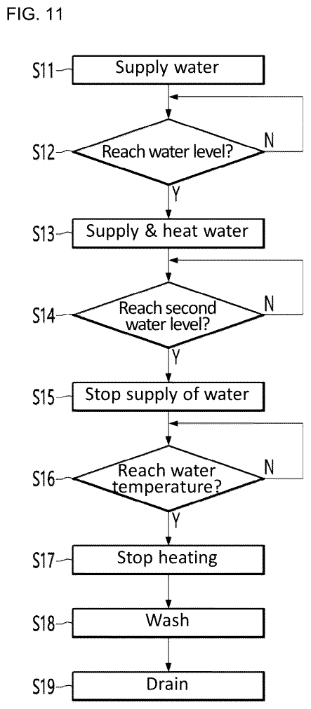

FIG. 11 is a flowchart showing a washing process of the washing machine according to the present embodiment.

Referring to FIG. 11, in the washing process of the drum washing machine according to the present embodiment, when a washing cycle starts, water is supplied into the water storage tub 2 and the water storage tub 2 is filled from a bottom (S11). In this case, a control module (not shown) determines whether the water is filled up to a first water level, that is, a water level at which the heating device 100 starts to be submerged (S12), and when the water is filled to the first water level according to the result, the control module starts to heat the water in the water storage tub by driving the heating device 100 (S13). In this case, the first water level is detected through the water level detection sensor 180 provided inside the waterway 12 of the heating device 100.

In addition, the control module controls the heating device 100 to be driven and water to be continuously supplied up to a set water level. Subsequently, the control module determines whether the water has been filled up to a second water level, that is, a set water level at which washing is possible (S14), and stops supply of the water when the water has been filled up to the first water level according to the result (S15). Simultaneously, the control module monitors whether a temperature of the water reaches a set temperature, that is, a temperature at which boiling washing is possible (S16), and when the temperature of the water reaches the set temperature, the control module controls the driving of the heating device 100 to stop the heating (S17). As described above, since the water starts to be heated when a predetermined amount of water is filled in the lower portion of the water storage tub 20, that is, when the heating device 100 is locked, a total time required for the washing cycle may be reduced.

The control module controls the driving motor 5 to perform washing (S18), and performs a series of washing cycles by performing drainage after the washing for a predetermined time (S19). The process of supplying water, heating, washing, and draining is repeated several times, as necessary.

The reduction of a washing time according to one embodiment of the present invention may be achieved by a configuration in which the heating device 100 includes the water level detection sensor 180, and the heating device 100 according to the present is configured to accurately detect the water level to prevent the heating device from being damaged.

In the description of the heating device of the present embodiment, an example applied to the washing machine is described, but the heating device may be applied to various types of clothes care machines that manage clothes by heating water or generating steam, such as a refresher.

Although an exemplary embodiment of the present invention has been illustrated and described as described above, various modifications and other embodiments may be made by those skilled in the art. These modifications and other embodiments are all considered in the appended claims and will be included without departing from the true spirit and scope of the present invention.

1. A heating device for a clothes care machine, which is mounted in a water storage space inside the clothes care machine to heat water, the heating device comprising:
a heating plate which is a plate having a predetermined thickness and formed on an outer surface thereof with a heating surface;
a heating electrode layer which provides an electrode pad at one side thereof and is formed on an inner surface of a side of the heating plate, which is opposite to the heating surface;
a lead electrode which has one end connected to the electrode pad to supply power to the heating electrode layer;
a housing which accommodates and protects the heating plate and a portion of the lead electrode such that the heating surface is exposed; and
a bracket which is coupled to a side of the housing to fix another end of the lead electrode while exposing another end of the lead electrode to an outside,
wherein the housing is mounted in the clothes care machine such that the housing is located in the water storage space to heat the water while being submerged in the water filled in the water storage space.

2. The heating device of claim 1, wherein the heating surface is bent such that a central region of the heating plate is concave inwardly.

3. The heating device of claim 2, wherein the heating surface is configured as a slope structure having concavely bent region with a variable depth.

4. The heating device of claim 2, wherein the heating plate is formed with a reinforcement flange that is formed by bending inward an edge of the heating plate.

5. The heating device of claim 1, further comprising a resistance electrode layer which is formed on a surface of the heating plate within the heating electrode layer to measure a resistance of the heating plate according to a temperature.

6. The heating device of claim 5, wherein the heating electrode layer and the resistance electrode layer are formed by printing a heating paste on a surface of the heating plate.

7. The heating device of claim 5, wherein the resistance electrode layer functions as a heating electrode layer to which the power is applied so as to allow the resistance electrode layer to heat a surface of a local area of the heating plate.

8. The heating device of claim 1, wherein an upper surface of the housing is concavely recessed to form an avoidance groove in order to prevent a contact with a rotating body.

9. The heating device of claim 1, further comprising a sealing member which is interposed between the housing and the bracket to prevent leakage of the water filled in the water storage space.

10. The heating device of claim 9, wherein the housing includes a movement prevention unit which prevents movement of the sealing member.

11. The heating device of claim 10, wherein the movement prevention unit includes a support part protruding along a surface of the housing, and a pressing part extending from an upper end of the support part toward the sealing member, and
the pressing part is configured to prevent the movement of the sealing member by pressing an end of the sealing member.

12. The heating device of claim 1, further comprising a water level detection sensor which is mounted on the housing to detect a water level in the water storage space.

13. The heating device of claim 12, wherein the housing has a concave waterway along an edge of an upper surface thereof, and
the water level detection sensor is installed such that one end thereof extends to the waterway, so as to detect a level of water introduced into the waterway.

14. The heating device of claim 13, wherein the waterway has a blocking wall formed at an outer end thereof so that the waterway is blocked from an outer region, and is configured to introduce the water to an inside or to discharge the water to the outside through a through-hole formed in the blocking wall.

15. The heating device of claim 1, wherein the lead electrode is integrally coupled to the bracket while passing through the bracket, and includes a contact terminal located inside the bracket and a lead terminal located outside the bracket, and
the housing has adhering protrusions formed on an inner surface thereof to improve a contact force by pressing the contact terminal with the electrode pad.
